(19) United States
(12) Patent Application Publication
(10) Pub. No.: US 2007/0207330 A1
(43) Pub. Date: Sep. 6, 2007

(54) Adhesive protective coatings, non-line of sight methods for their preparation, and coated articles

(76) Inventors: Sonia Tulyani, Manchester, CT (US); John G. Smeggil, Simsbury, CT (US); Tania Bhatia, Middletown, CT (US)

Correspondence Address: BACHMAN & LAPOINTE, P.C. (P&W), 900 CHAPEL STREET, SUITE 1201, NEW HAVEN, CT, 06510-2802, US

(21) Appl. No.: 11/366,768

(22) Filed: Mar. 1, 2006

(51) Int. Cl. B32B 15/04; B32B 9/00; B32B 19/00; B05D 1/18; B05D 3/02; B05D 7/00; C09D 1/00

(52) U.S. Cl. 428/472; 428/701; 428/702; 427/430.1; 427/374.1; 427/402; 106/286.4; 106/286.1; 106/286.5; 106/287.34; 106/287.1; 106/286.6

(57) ABSTRACT

A method for depositing a protective coating upon a substrate includes the steps of dipping a substrate into a slurry composed of an aqueous solution, at least one refractory metal oxide, and at least one transient fluid additive present in an amount of about 0.1 percent to 10 percent by weight of the slurry; heat treating the substrate; and cooling the substrate to form a protective coating thereon.

### GOVERNMENT RIGHTS

The Government of the United States of America may have rights in the present invention pursuant to Contract No. DE-FC26-00CH11060 awarded by the Department of Energy.

### FIELD OF USE

The present disclosure relates to protective coatings and, more particularly, relates to a cost effective process for preparing and applying protective coatings of tailored density effective at limiting the damaging environmental effects and/or providing thermal protection and thereby extending service life of complex shaped parts in all applicable industries.

### BACKGROUND OF THE INVENTION

In the known scientific literature, environmental barrier coatings (EBCs) are coatings used to prevent the volatilization of Si-species from a silicon containing substrate, e.g., U.S. Pat. No. 6,387,456 to Eaton et. al. Thermal barrier coatings (TBCs) are used for the thermal protection of metal substrates, e.g., Ni-based superalloys, etc., in various applications such as those described in an article by D. R. Clarke and C. G. Levi, Annual Review of Materials Research, 20003, Vol. 33, pp. 383-417. Often an EBC will also act as a TBC and vice versa. TBCs/EBCs are also used for the protection of certain oxide/oxide ceramic composites as described in U.S. Pat. No. 7,001,679 to Campbell and Lane. While a large number of issued and published patents describe environmental and thermal barrier compositions, there is a relative scarcity of methods directed to applying such protective coatings to complex shaped parts that are difficult to coat by line of sight methods. Often gas turbine engine components, heat exchangers, etc. have complex shapes and are difficult to coat by coating methods known in the art such as thermal spray and electron-beam physical vapor deposition.

Suitable coating processes for such complex shaped parts must provide thick, dense coatings of 1-100 mils at a low cost and rapid production rate. Both plasma spraying and physical vapor deposition processes are line of sight processes are not practical for rapidly coating complex geometries. A non-line of sight process often used to provide dense coatings is chemical vapor deposition (“CVD”). Although this technique provides thick, dense coatings, CVD processes are expensive, slow and require a great deal of process development and operator skill. Alternatives to CVD are highly desirable because the process uses environmentally unfriendly chemical precursors and often generates waste products that require extensive clean-up.

Recently, a coating process involving electrophoretic deposition (“EPD”) as a non-line of sight method was disclosed in U.S. Publ. No. 2006/0029733A1, published on Feb. 9, 2006 and assigned to the assignee of reference in the present application, United Technologies Corporation. EPD processes cannot be easily applied and require an electrically conductive substrate and a complex electrode design to deposit uniform coating(s) upon the substrates.

Another coating process involves sol-gel. Sol-gel processes are often used to coat complex shaped substrates. Sol-gel processes produce dense coatings in a rapid and inexpensive manner. However, the thickness of coatings deposited from sol-gel processes is limited which makes the process unsuitable where the coating must be thick and dense enough to withstand exposure to harsh environmental conditions.

Yet another coating process involves dip coating. Dip coating is recognized as a suitable, cost efficient process for depositing protective coatings upon complex shaped substrates as disclosed in the article entitled “Tailored Rheological Behavior of Mullite and BSAS Suspensions using a Cationic Polyelectrolyte” by Armstrong, Beth, et al., American Society of Mechanical Engineers, Paper GT 2005-68491, presented in Reno, Nev. (June, 2005). Generally, dip coating processes are non-line-of-sight and do not require expensive or complex equipment. However, current dip coating processes produce coatings that often exhibit poor adhesion and non-uniformity in thickness.

In traditional slurry-based ceramic processing the sintering temperatures of ceramics are usually 0.7-0.8 Tₘ, where Tₘ is the homologous melting temperature of the ceramic. Sintering of the ceramic imparts good cohesive strength to the ceramic by promoting densification. However, in the case of ceramic coatings, such as EBCs and TBCs, on metals or ceramic components, it is not possible to heat the article to the high temperatures required to promote acceptable densification of the ceramic coating material because of various material constraints, e.g., such as the likely melting of bond layer and or metal component. The low sintering temperatures also limit the adhesion of the coatings. Presently, it is recognized that high processing temperatures are necessary in order to improve poor adhesion. However, the physical properties of the intended substrates prevent utilizing these requisite high processing temperatures.

Consequently, there exists a need for a cost effective process for preparing and applying coatings that act as barriers to corrosive environments, providing a thermal barrier function and extending the service life of complex shaped parts in all applicable industries.

### SUMMARY OF THE INVENTION

In accordance with the present invention, a method for depositing a protective coating upon a substrate broadly comprises the steps of dipping a substrate into a slurry, the slurry comprising an aqueous solution, at least one refractory metal oxide, and at least one transient fluid additive present in an amount of about 0.1 percent to 10 percent by weight of the slurry; heat treating the substrate; and cooling the substrate to form a protective coating thereon.

In accordance with another aspect of the present invention, an article coated in accordance with a process broadly comprising the steps of dipping an article into a slurry, the slurry comprising an aqueous solution, at least one refractory metal oxide, and at least one transient fluid additive in an amount of about 0.1 percent to 10 percent by weight of the slurry; heat treating the article; and cooling the article to form a protective coating.

In accordance with yet another aspect of the present invention, a coating composition broadly comprises a reaction product of at least one refractory metal oxide and at least one transient fluid additive, wherein the reaction product comprises a thermal conductivity value range of about 0.5 W/mK to about 6 W/mK.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a representation of a portion of a substrate coated with an optional bond coat layer, an optional intermediate layer and a protective top coat layer;

FIG. 2 is a representation of a portion of a substrate coated with an optional bond coat layer and a protective top coat layer;

FIG. 3 is a representation of a portion of a substrate coated with a protective top coat layer; and

FIG. 4 is a flow chart depicting a method for depositing a protective coating on a complex shaped substrate.

Like reference numbers and designations in the various drawings indicate like elements.

### DETAILED DESCRIPTION

The present invention relates to a method for applying a protective coating to silicon containing articles and the coated silicon containing articles. The protective coating inhibits the formation of gaseous species of silicon when the article is exposed to a high temperature, combustion environments. The protective coating may serve as an environmental barrier layer, a thermal barrier layer or a chemical barrier layer.

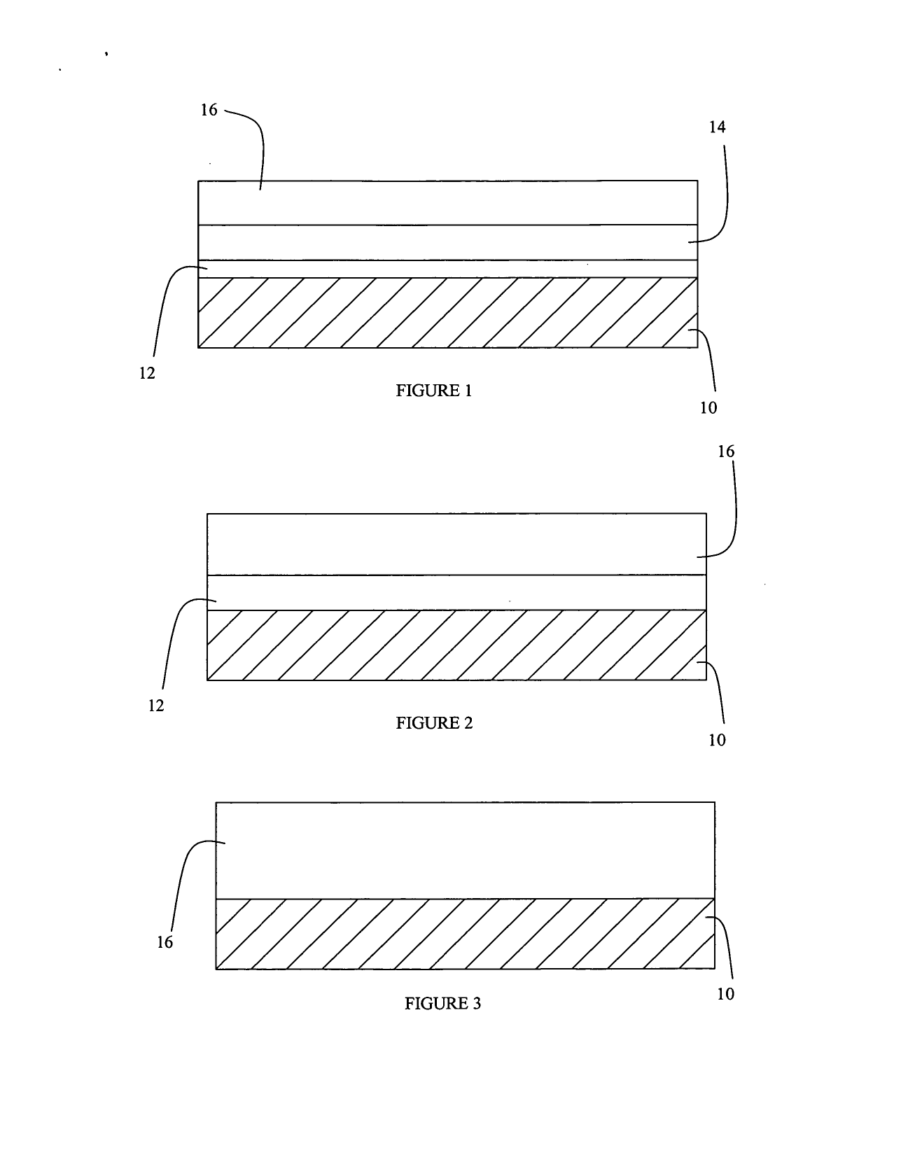

Referring to FIGS. 1-3, a portion of a complex shaped part is represented by a substrate 10. As used herein, the term “complex shaped part” means a part whose shape and geometry are not conducive to being coated by conventional line-of-sight methods known to one of ordinary skill in the art. Various industries employ complex shaped parts and all of these complex shaped parts may be coated using the methods of the present invention. For example, aircraft engine manufacturers may utilize the methods of the present invention to coat complex shaped parts such as vanes, rotors blades, combustor liners, shrouds, transition ducts, airfoils, and substantially tubular gas turbine components. Many other complex shaped turbine engine and turbomachinery components may be coated using the methods of the present invention. For example, an integral vane assembly which consists of a set of 8 to 20 vanes with integral outer and inner platforms, including multiple airfoils mounted between platforms and integral turbine blade assemblies, may all be coated using the methods of the present invention.

Generally, the substrate 10 may comprise a ceramic material, a metal-based material, combinations comprising at least one of the foregoing, and the like. For example, substrate 10 may include, but is not limited to, high temperature iron alloys and steels, Ni-based superalloys, silicon-containing ceramics, silicon-containing metal alloys, and oxide-oxide containing materials. Suitable silicon-containing ceramics may include, but are not limited to, silicon nitride, silicon carbide, silicon carbide composites, silicon nitride composites, silicon oxynitrides, silicon aluminum oxynitrides, silicon nitride ceramic matrix composites, combinations comprising at least one of the foregoing, and the like. Suitable silicon-containing metal alloys may include, but are not limited to, molybdenum silicon alloys, niobium silicon alloys, iron silicon alloys, cobalt silicon alloys, nickel silicon alloys, tantalum silicon alloys, refractory metal silicides, combinations comprising at least one of the foregoing, and the like. Suitable oxide-oxide materials may include, but are not limited to, fiber reinforced oxide matrix composites where the fiber reinforcements may include, but are not limited to, silicon carbide, silicon nitride, alumina, mullite, combinations comprising at least one of the foregoing oxide-oxide materials, and the like; and, the oxide matrix may include, but are not limited to, alumina, zirconia, mullite, comparable refractory oxides, combinations comprising at least one of the foregoing, and the like.

Referring again to FIGS. 1-3, a bond coat layer 12 may optionally be disposed onto the surface of substrate 10. Bond coat layer 12 may comprise at least one metal-based composition suitable for use with the silicon-containing substrate materials. Suitable bond coat layer materials may include, but are not limited to, silicon, hafnium oxide, hafnium silicon oxide, combinations comprising at least one of the foregoing, and the like. An intermediate layer 14 may optionally be disposed onto the bond coat layer 12. Intermediate layer 14 may comprise at least one metal-based composition suitable for use with the silicon-containing substrate materials. Suitable intermediate layer materials may include, but are not limited to, HfSiO₄, BaSiO₂, SrSiO₂, aluminum silicate, yttrium silicate, rare earth silicates, mullite and alkaline earth aluminosilicates of barium and strontium.

A protective layer 16 may be disposed upon the substrate 10, or if present, upon the bond coat layer 12 or the intermediate layer 14. The protective layer 16 may comprise about 50 to 100 mol. % of at least one refractory metal oxide. Any refractory metal oxide may be employed, for example, hafnium oxide and/or monoclinic hafnium oxide. In addition, the protective layer 16 may further comprise up to about 50 mol. % of at least one other refractory metal oxide having at least one metal selected from the group comprising Zr, Ti, Nb, Ta, Ce and mixtures thereof. In other embodiments, the protective layer 16 may further comprise up to about 50 mol. % of at least one other refractory metal oxide having a metal selected from the group comprising rare earth elements, Y, Sc, Al, Si and mixtures thereof. In other embodiments, the protective layer 16 may further comprise up to about 50 mol. % of at least one other refractory metal oxide having a metal selected from the group comprising Ba, Sr, Si, Al and mixtures thereof. In other embodiments, the protective layer may further comprise up to about 50 mol. % of at least one other refractory metal oxide or at least one silicate having a metal selected from the group comprising rare earth elements, Y, Sc, La, Gd, Sm, Lu, Yb, Er, Pr, Pm, Dy, Ho, Eu and mixtures thereof.

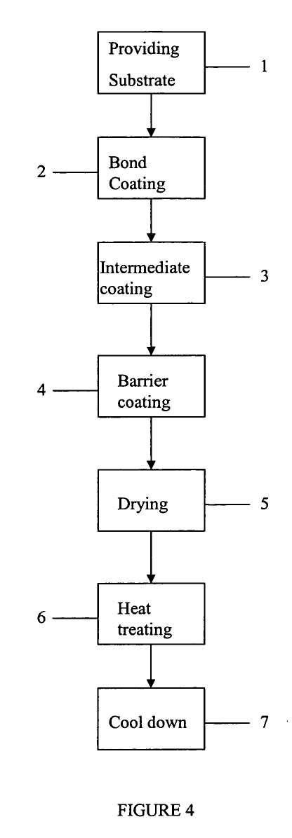

Referring to FIG. 4, the method(s) for applying the protective coatings described herein improve the overall adhesion and uniformity of the protective coatings upon the substrate. For purposes of illustration, and not to be taken in a limiting sense, the method may be described in a series of steps, some of which may be optional, and whose order may be changed dependent upon factors such as, but not limited to, the intended application, process conditions, and the like. The method generally comprises providing a substrate as described above at step 1 in FIG. 4. The substrate may include an optional bond coat layer 12 disposed between the substrate 10 and the aforementioned optional intermediate layer 14 as shown at step 2 in FIG. 4. The optional intermediate layer 14 may be disposed between the optional bond coat layer 12 and the aforementioned protective layer 16 or between the substrate 10 and the aforementioned bond coat layer 12 as shown at step 3 in FIG. 4.

The optional bond coat layer 12 may be applied to the silicon containing substrate 10 by any suitable manner known in the art, such as, but not limited to, thermal spraying, slurry coating, vapor deposition (chemical and physical), combinations comprising at least one of the foregoing methods, and the like. The optional intermediate layer 14 may also be applied to the substrate 10 or optional bond coat layer 12 by these same methods, and combinations, as known in the art.

The protective layer 16 is preferably applied using a slurry dip coating technique. The slurry dip coating technique generally comprises dipping the silicon containing substrate, with or without the optional bond coat layer 12 and intermediate layers 14, into a slurry. The slurry may comprise an aqueous solution, a source of an oxide of a rare earth element, and one or more transient fluid additives. The aqueous solution may comprise any fluid compatible with the source of hafnium oxide, transient fluid additives and the substrate and its layers such as a solution comprising the rare earth element and their oxides such as, but not limited to, La, Gd, Sm, Lu, Yb, Er, Pr, Pm, Dy, Ho, Eu and mixtures thereof. Preferably, a solution comprising hafnium oxide and/or hafnia is used. The aqueous solution may also serve as the source of the oxide of a rare earth element by including one or more metal ion containing soluble salts. In the alternative, one of the aforementioned rare earth elements may be added to the aqueous solution and reacted to form the source of the oxide of the rare earth metal. Preferably, hafnium nitrate or hafnium acetate is added to the aqueous solution to react and form hafnium oxide.

Transient fluid additives may be used to promote grain growth and eliminate the formation of pores between grains. It has been discovered that adding the additives described below eliminate pore formation and promote grain growth allowing for improved adhesion. The transient fluid additives may generally comprise a source of silica or titania. Such silica and titania sources may include, but are not limited to, a precursor solution, a colloid, a suspension, a powder, and the like. Representative sources of silica include, but are not limited to, silicon oxide, lithium silicate, fumed silica powder, colloidal silica, combinations comprising at least one of the foregoing, and the like. Whether silica or titania is employed, it is recognized that the particle size can influence positively the adhesion between the layers, for example, between the protective coating and the optional intermediate layer or optional bond coat or silicon containing substrate. The transient fluid additive may comprise about 0.1 percent to about 10 percent by weight of the slurry, and preferably about 0.5 percent to about 8 percent by weight of the slurry, and most preferably about 1 percent to about 5 percent by weight of the slurry. In the case of using lithium silicate as the transient fluid additive and hafnium oxide as the source of the oxide of a rare earth element, for example, lithium silicate decomposes to form silicon oxide that reacts with the hafnium oxide forming a layer of hafnium silicate between the grains of hafnium oxide as well as between the hafnium oxide and silicon. As such, the reaction product of the transient fluid additive and refractory metal oxides of the protective layer effectively eliminate pore formation between the grains while also promoting grain growth and improving adhesion.

The silicon containing substrate 10, and optional bond coat layer 12 and intermediate layer 14, may be dipped into the slurry to form a base coat of the intended protective coating 16 as shown at step 4 in FIG. 4. Once the base coat forms, the coated substrate may be dried for about 12 hours (hrs) to 36 hrs, and preferably for about 18 hrs to 30 hrs, and most preferably for about 24 hours at an ambient temperature, for example, room temperature as shown at step 5 in FIG. 4. Once dried, the coated silicon containing substrate may be heat treated to a temperature range of about 300° C. to 500° C., and preferably about 400° C., at a rate of about 2° C. per minute to 5° C. per minute, and preferably about 3° C. per minute, and the temperature may be maintained for a time period of about 2 hrs to 4 hrs, and preferably about 3 hrs as shown at step 6 in FIG. 4. After that time, the temperature may be elevated to about 1250° C. to 1450° C., and preferably about 1350° C., at a rate of about 2° C. per minute to 5° C. per minute, and preferably about 3° C. per minute, and the temperature may be maintained for a time period of about 2 hrs to 7 hrs, and preferably about 5 hrs. Afterwards, the silicon containing substrate may be cooled at a rate of about 5° C. per minute to 15° C. per minute, and preferably about 10° C. per minute, until achieving an ambient temperature, for example, room temperature, as shown at step 7 in FIG. 4.

While most examples cited in this patent application deal with environmental barrier coatings (EBCs) applied to silicon-containing ceramic substrates, the substrates may be made of any ceramic compounds or refractory metals and nickel-based superalloys. The methods of the present invention relate to methods for the deposition of protective coatings upon complex shaped parts. These complex shaped parts are generally subjected to high temperature, aqueous and chemically harsh environments. Typically, such complex shaped parts are difficult, if not impossible at times, to coat efficiently by line-of-sight processes of the prior art. The geometry of the complex shaped part makes it difficult to coat by either a plasma gun or by gaseous precursor species in conventional physical deposition techniques. While focusing upon complex shaped parts that cannot be easily or efficiently coated by thermal spray/physical vapor deposition routes, the non-line-of-sight coating methods outlined in the present invention may serve as, for example, (i) a low cost method for processing and/or repairing coatings that are conventionally made by air plasma spray/electron beam-physical vapor deposition processes or (ii) a method to apply thin coatings of required dimensional tolerance upon complex shaped parts.

It is to be understood that the invention is not limited to the illustrations described and shown herein, which are deemed to be merely illustrative of the best modes of carrying out the invention, and which are susceptible to modification of form, size, arrangement of parts, and details of operation. The invention rather is intended to encompass all such modifications which are within its spirit and scope as defined by the claims.

1. A method for depositing a protective coating upon a substrate, comprising the steps of:
dipping a substrate into a slurry, said slurry comprising an aqueous solution, at least one refractory metal oxide, and at least one transient fluid additive present in an amount of about 0.1 percent to 10 percent by weight of said slurry;
heat treating said substrate; and
cooling said substrate to form a protective coating thereon.

2. The method of claim 1, further comprising applying a bond coat to said substrate prior to said dipping step.

3. The method of claim 2, further comprising applying an intermediate layer upon said bond coat prior to said dipping step.

4. The method of claim 1, further comprising the step of drying said substrate before said heat treating step.

5. The method of claim 4, wherein drying comprises exposing said substrate to the atmosphere for about twenty-four hours.

6. The method of claim 1, wherein heat treating comprises the following steps:
heating said substrate to a first temperature of about 400° C. at a rate of about 3° C. per minute;
maintaining said first temperature for about three hours;
heating said substrate from said first temperature to a second temperature of about 1350° C. at a rate of about 3° C. per minute; and
maintaining said second temperature for about seven hours.

7. The method of claim 1, wherein cooling comprises lowering a temperature at a rate of about 10° C. per minute until achieving an ambient temperature.

8. The method of claim 1, wherein said at least one refractory metal oxide comprises about 50 mol. % to 100 mol. % of a first refractory metal oxide and up to about 50 mol. % of at least one second refractory metal oxide comprising a metal selected from the group consisting of hafnium, zirconium, titanium, niobium, tantalum, cerium, yttrium, scandium, aluminum, silicon, barium, strontium, scandium, lanthanum, gadolinium, samarium, luteium, ytterbium, europium, praseodymium, dysprosium, erbium, promethium and holmium.

9. The method of claim 1, wherein said at least one transient fluid additive comprises a silica based material selected from the group consisting of silicon oxide, lithium silicate, fumed silica powder and colloidal silica.

10. The method of claim 1, wherein said at least one transient fluid additive comprises a titania based material.

11. An article coated in accordance with a process comprising the steps of:
dipping an article into a slurry, said slurry comprising an aqueous solution, at least one refractory metal oxide, and at least one transient fluid additive in an amount of about 0.1 percent to 10 m percent by weight of said slurry;
heat treating said article; and
cooling said article to form a protective coating.

12. The article of claim 11, wherein said article is a component of a gas turbine engine.

13. The article of claim 12, wherein said component comprises at least one of: a vane, a blade, a combustor liner, a shroud, a transition duct and an airfoil.

14. The article of claim 12, wherein said component has a complex shape.

15. The article of claim 12, wherein said complex shape is substantially tubular.

16. The article of claim 12, wherein said component further comprises a surface having a protective coating disposed thereupon.

17. The article of claim 16, wherein said protective coating comprises a reaction product of at least one refractory metal oxide and a transient fluid additive, wherein the reaction product comprises a thermal conductivity value range of about 0.5 W/mK to about 6 W/mK.

18. The article of claim 17, wherein said at least one refractory metal oxide comprises about 50 mol. % to 100 mol. % of a first refractory metal oxide and up to about 50 mol. % of at least one second refractory metal oxide comprising a metal selected from the group consisting of hafnium, zirconium, titanium, niobium, tantalum, cerium, yttrium, scandium, aluminum, silicon, barium, strontium, scandium, lanthanum, gadolinium, samarium, luteium, ytterbium, europium, praseodymium, dysprosium, erbium, promethium, holmium, and mixtures thereof.

19. The article of claim 16, further comprising a bond coat disposed between said surface and said protective coating.

20. The article of claim 19, wherein said bond coat comprises at least one of: silicon, hafnium oxide and hafnium silicon oxide.

21. The article of claim 19, further comprising an intermediate layer disposed between said bond coat and said protective coating.

22. The article of claim 21, wherein said intermediate layer comprises a material selected from the group consisting of HfSiO₄, BaSiO₂, SrSiO₂, aluminum silicate, yttrium silicate, rare earth silicates, mullite, alkaline earth aluminosilicates of barium, alkaline earth aluminosilicates of strontium and mixtures thereof.

23. The article of claim 21, wherein said intermediate layer comprises at least one of: silicon, hafnium oxide and hafnium silicon oxide.

24. A coating composition, comprising:
a reaction product of at least one refractory metal oxide and at least one transient fluid additive,
wherein the reaction product comprises a thermal conductivity value range of about 0.5 W/mK to about 6 W/mK.

25. The coating composition of claim 24, wherein said at least one refractory metal oxide comprises about 50 mol. % to 100 mol. % of a first refractory metal oxide and up to about 50 mol. % of at least one second refractory metal oxide comprising a metal selected from the group consisting of hafnium, zirconium, titanium, niobium, tantalum, cerium, yttrium, scandium, aluminum, silicon, barium, strontium, scandium, lanthanum, gadolinium, samarium, luteium, ytterbium, europium, praseodymium, dysprosium, erbium, promethium, holmium, and mixtures thereof.

26. The coating composition of claim 24, wherein said at least one transient fluid additive comprises at least one silica based material selected from the group consisting of silicon oxide, lithium silicate, fumed silica powder and colloidal silica.

27. The coating composition of claim 24, wherein said at least one transient fluid additive comprises at least one titania based material.
